(19) United States
(12) Patent Application Publication
(10) Pub. No.: US 2026/0222164 A1
(43) Pub. Date: Jul. 30, 2026

(54) TERMINAL, AND BASE STATION

(71) Applicant: NTT DOCOMO, INC., Tokyo (JP)

(72) Inventors: Mayuko Okano, Tokyo (JP); Naoya Shibaike, Tokyo (JP); Hiroki Harada, Tokyo (JP); Yuki Takahashi, Tokyo (JP)

(73) Assignee: NTT DOCOMO, INC., Tokyo (JP)

(21) Appl. No.: 19/574,023

(22) Filed: Mar. 20, 2026

Related U.S. Application Data
(63) Continuation of application No. 18/260,849, filed on Jan. 15, 2021, now abandoned.

(51) Int. Cl. H04L 5/00; H04W 72/20

(52) U.S. Cl. CPC H04L 5/0094; H04W 72/20

(57) ABSTRACT

A terminal uses a second subcarrier spacing greater than the first subcarrier spacing. The terminal includes a transmitter that transmits predetermined terminal capability information relating to a Physical Downlink Control Channel (PDCCH) monitoring. The terminal further includes a controller that performs the PDCCH monitoring with a number of PDCCH candidates equal to a maximum number of PDCCH candidates in the first subcarrier spacing. The terminal also includes a receiver that receives downlink control information transmitted on the monitored PDCCH.

### CROSS-REFERENCE TO RELATED APPLICATIONS

This application is a continuation application of U.S. Patent Application No. 18/260,849, filed on July 10, 2023, which is a national phase application of PCT/JP2021/001382, filed on January 15, 2021. The contents of these applications are hereby incorporated by reference in their entirety.

### FIELD OF THE INVENTION

The present invention relates to a terminal and a base station in a wireless communication system.

### BACKGROUND OF THE INVENTION

Regarding NR (New Radio) (also referred to as "5G"), or a successor system to LTE (Long Term Evolution), technologies have been discussed which satisfy the following requirements: a high capacity system, high data transmission rate, low delay, simultaneous connection of multiple terminals, low cost, power saving, etc. In addition, in NR, using a high frequency band such as 52.6 GHz to 71 GHz, or 24.25 GHz to 71 GHz has been discussed.

Further, the conventional LTE system supports the use of frequency bands (also referred to as unlicensed bands, unlicensed carriers, and unlicensed CCs) different from the frequency bands (licensed bands) licensed to telecommunication operators, in order to expand frequency bands. Regarding the unlicensed band, the 2.4 GHz band, the 5 GHz band, or the 6 GHz band where Wi-Fi (registered trademark) or Bluetooth (registered trademark) can be used, is assumed to be the unlicensed band. The system that supports unlicensed bands in NR is referred to as an NR-U system.

### Citation List

### Non-Patent Document

[Non-Patent Document 1] 3GPP TS 38.331 V15.8.0 (2019-12)

[Non-Patent Document 2] 3GPP TS 38.133 V16.1.0 (2019-09)

[Non-Patent Document 3] 3GPP TS 38.213 V16.1.0 (2020-03)

[Non-Patent Document 4] 3GPP TS 38.306 V16.1.0 (2020-07)

### SUMMARY OF THE INVENTION

### TECHNICAL PROBLEM

In NR, various functions are defined for the monitoring of a control channel by a terminal (for example, Non-Patent Documents 1 to 4).

However, there is a possibility that a terminal, which conforms to the conventional definition in which a frequency band is assumed to be up to 52.6 GHz, cannot appropriately perform monitoring in the high frequency band higher than 52.6.

The present invention has been made in view of the above, it is an object of the present invention to provide a technique that enables a terminal to perform monitoring of a control channel in the high frequency band in a wireless communication system.

### SOLUTION TO PROBLEM

According to the disclosed technology, a terminal is provided. The terminal includes: a control unit configured to perform monitoring of a control channel in an area in which, in a case of using a certain SCS, a number of symbols is greater than a number of symbols corresponding to another SCS that is less than the certain SCS; and a reception unit configured to receive control information via the control channel.

### ADVANTAGEOUS EFFECTS OF INVENTION

According to the disclosed technique, a technique is provided which enables a terminal to perform appropriate monitoring of a control channel in the high frequency band in a wireless communication system.

### BRIEF DESCRIPTION OF THE DRAWINGS

FIG. 1 is a drawing illustrating a wireless communication system according to an embodiment of the present invention.

FIG. 2 is a drawing illustrating a wireless communication system according to an embodiment of the present invention.

FIG. 3 is a drawing illustrating an example of a band.

FIG. 4 is a drawing illustrating an example of monitoring.

FIG. 5 is a drawing illustrating an example of monitoring.

FIG. 6 is a drawing illustrating an example of a span pattern.

FIG. 7 is a drawing illustrating an example of monitoring.

FIG. 8 is a drawing illustrating an example of a basic operation of a system.

FIG. 9 is a drawing illustrating an example of a basic operation of a system.

FIG. 10 is a drawing illustrating an embodiment 1.

FIG. 11 is a drawing illustrating an embodiment 1.

FIG. 12 is a drawing illustrating an embodiment 1.

FIG. 13 is a drawing illustrating an embodiment 1.

FIG. 14 is a drawing illustrating an embodiment 1.

FIG. 15 is a drawing illustrating an embodiment 2.

FIG. 16 is a drawing illustrating an embodiment 2.

FIG. 17 is a drawing illustrating an embodiment 2.

FIG. 18 is a drawing illustrating an example of a functional structure of a base station 10 in an embodiment of the present invention.

FIG. 19 is a drawing illustrating an example of a functional structure of a terminal 20 in an embodiment of the present invention.

FIG. 20 is a drawing illustrating an example of a hardware structure of the base station 10 or the terminal 20 in an embodiment of the present invention.

### DETAILED DESCRIPTION

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used appropriately. A conventional technique is a conventional NR. A wireless communication system (a base station 10 and a terminal 20) in an embodiment of the present invention basically performs an operation in accordance with the conventional definitions. Note that, in order to solve the problem to be solved in a case where the use of high frequency band is assumed, the base station 10 and the terminal 20 may perform an operation that is not defined in the conventional definition. In the following descriptions of the embodiments, an operation that is not defined in the conventional definition is mainly described. Note that the values described in the following descriptions are examples.

Furthermore, in an embodiment of the present invention, the duplex scheme may be TDD (Time Division Duplex) scheme, FDD (Frequency Division Duplex) scheme, or other schemes (e.g., Flexible Duplex, or the like).

Further, in an embodiment of the present invention, the expression, a radio (wireless) parameter is "configured" may mean that a predetermined value is pre-configured, or may mean that a radio parameter indicated by the base station 10 or the terminal 20 is configured.

### System configuration

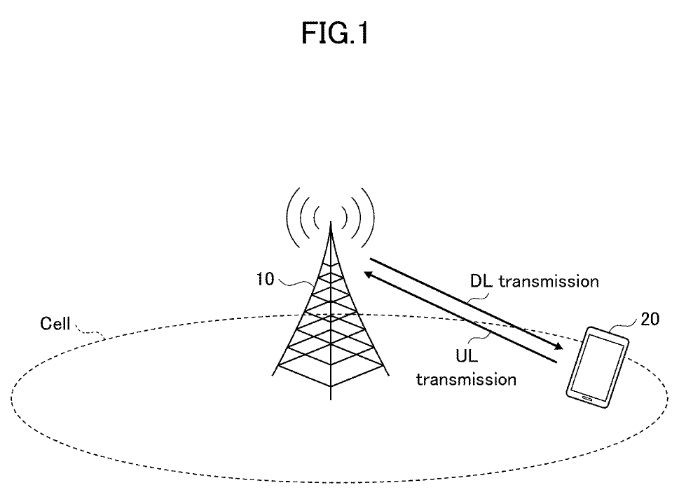

FIG. 1 is a drawing illustrating a wireless communication system according to an embodiment of the present invention. As illustrated in FIG. 1, a wireless communication system according to an embodiment of the present invention includes a base station 10 and a terminal 20. In FIG. 1, a single base station 10 and a single terminal 20 are illustrated as an example. There may be a plurality of base stations 10 and a plurality of terminals 20.

The base station 10 is a communication device that provides one or more cells and performs wireless communications with the terminal 20. A physical resource of a wireless signal is defined in the time domain and the frequency domain.

OFDM may be used as a wireless access method. In the frequency domain, with respect to the subcarrier spacing (SCS), at least 15 kHz, 30 kHz, 120 kHz, and 240 kHz may be supported. In an embodiment of the present invention, larger SCSs are supported. In addition, a resource block may include a predetermined number of (e.g., 12) consecutive sub-carriers regardless of the SCS.

When performing the initial access, the terminal 20 detects an SSB (SS/PBCH block), and identifies an SCS of PDCCH and PDSCH, based on PBCH included in the SSB.

In addition, in the time domain, a plurality of OFDM symbols (for example, as many as 14, regardless of the subcarrier spacing) are included in a slot. Hereinafter, an OFDM symbol is referred to as a “symbol”. The slot is a unit of scheduling. In addition, a subframe with 1 ms section period is defined, and a frame including 10 subframes is defined. Note that the number of symbols per slot is not limited to 14.

As shown in FIG. 1, the base station 10 transmits control information or data in DL (Downlink) to the terminal 20 and receives control information or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, both the base station 10 and the terminal 20 may perform communications via an SCell (Secondary Cell) and a PCell (Primary Cell) using CA (Carrier Aggregation).

The terminal 20 may be a communication apparatus that includes a wireless communication function, such as a smart-phone, a mobile phone, a tablet, a wearable terminal, a communication module for M2M (Machine-to-Machine), or the like. As shown in FIG. 1, the terminal 20 uses various communication services provided by the wireless communication system by receiving control information or data in DL from the base station 10 and transmitting control information or data in UL to the base station 10.

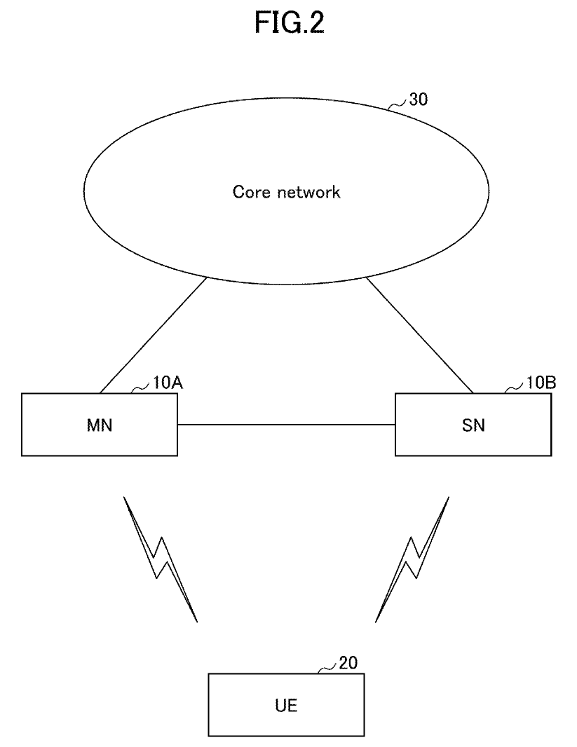

FIG. 2 shows an example of a configuration of a wireless communication system in a case where NR-DC (NR-Dual connectivity) is performed. As shown in FIG. 2, a base station 10A serving as an MN (Master Node) and a base station 10B serving as an SN (Secondary Node) are provided. The base station 10A and the base station 10B are each connected to a core network. The terminal 20 communicates with both the base station 10A and the base station 10B.

A cell group provided by the base station 10A serving as an MN is called an MCG (Master Cell Group), and a cell group provided by the base station 10B serving as an SN is called an SCG (Secondary Cell Group). Operations in an embodiment of the present invention may be performed in any of the configurations of FIG. 1 and FIG. 2.

In a wireless communication system according to an embodiment of the present invention, in a case where an unlicensed band is used, LBT (Listen Before Talk) may be executed. The base station 10 or the terminal 20 performs transmission in a case where the LBT result is idle, and does not perform transmission in a case where the LBT result is busy.

### Regarding frequency band

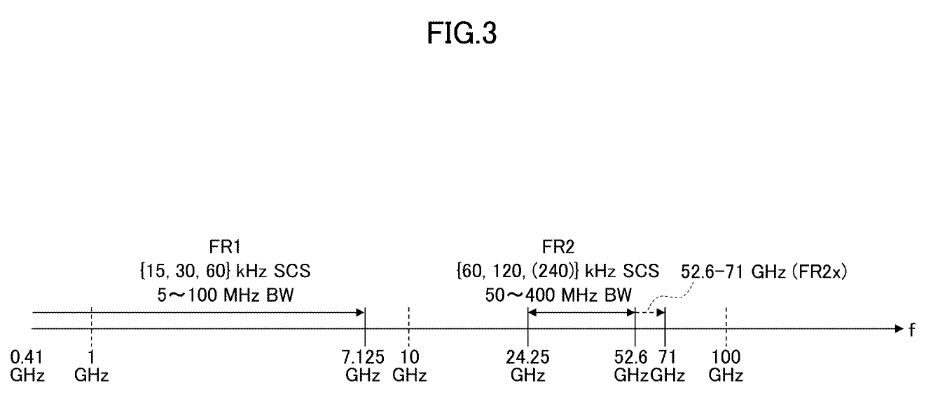

FIG. 3 illustrates an example of a frequency band used in conventional NR and a frequency band used in a wireless communication system according to this embodiment. There are two frequency bands (also referred to as frequency ranges) for conventional NR: FR1 (0.41 GHz to 7.125) and FR2 (24.25 GHz to 52.6 GHz). As shown in FIG. 3, FR1 supports 15 kHz, 30 kHz, and 60 kHz as SCS and supports 5-100 MHz as bandwidth (BW). FR2 supports 60 kHz, 120 kHz and 240 kHz (SSB only) as SCS and supports 50-400 MHz as bandwidth (BW).

In the wireless communication system according to an embodiment of the present invention, it is assumed that the frequency band of 52.6 GHz to 71 GHz, which is not used in the conventional NR, is used. In FIG. 3, for the sake of convenience, the frequency band of 52.6 GHz to 71 GHz is described as FR2x. In addition, in an embodiment of the present invention, the frequency band of 24.25 GHz to 71 GHz may be used as an extended FR2.

In addition, in an embodiment of the present invention, a wider SCS than conventional SCSs is used in accordance with the expansion of the frequency band as described above. For example, an SCS of 480 kHz or greater than 480 kHz may be used as an SCS of SSB and PDCCH/PDSCH. Note that, for example, 480 kHz SCS may be used for SSB, and 240 kHz SCS may be used for PDCCH/PDSCH.

### Regarding the problem to be solved

As described above, in an embodiment of the present invention, an SCS (for example, 480 kHz) that is wider than the conventional FR2 SCS is used as an SCS in the frequency band of 52.6 GHz to 71 GHz, or 24.25 GHz to 71 GHz.

In a wireless communication system such as NR, the terminal 20 performs data transmission and reception, etc., by receiving the downlink control information (DCI) transmitted from the base station 10 via a downlink control channel (specifically, PDCCH). Accordingly, the terminal 20 monitors the downlink control channel.

According to the tendency in the conventional technology (for example, Table 10.1-2, Table 10.1-3) specified in the Non-Patent Document 3, or the like, due to the limitation of the terminal processing capability, it is assumed that the number of PDCCH candidates that should be monitored by the terminal 20, the maximum number of BDs (Blind Decoding), the maximum number of CCEs, or the like, will become smaller as the SCS becomes larger. In this case, AL (aggregation level) becomes smaller as the number of CCEs decreases, and thus, sufficient resources cannot be secured and the reliability becomes lower.

More specifically, for example, from the descriptions in Table 10.1-3 in the Non-Patent Document, it is assumed that the maximum number of CCEs per slot to be monitored by the terminal 20 is 16 in a case where the SCS is 240 kHz (i.e., in a case where μ=4) and 1 or 2 in a case where the SCS is 480 kHz (i.e., in a case where μ=5). In addition, in a case where the SCS is 960 kHz, it is likely that even one high-AL PDCCH per slot cannot be monitored. In addition, in a case where the SCS becomes larger, the type of DCI to be monitored within one slot will be also limited.

In TR 38.822 (hereinafter, referred to as “reference document 1”) or in Non-Patent Document 4, the following capabilities are defined as conventional terminal capabilities.

### 1 One monitoring occasion per one slot

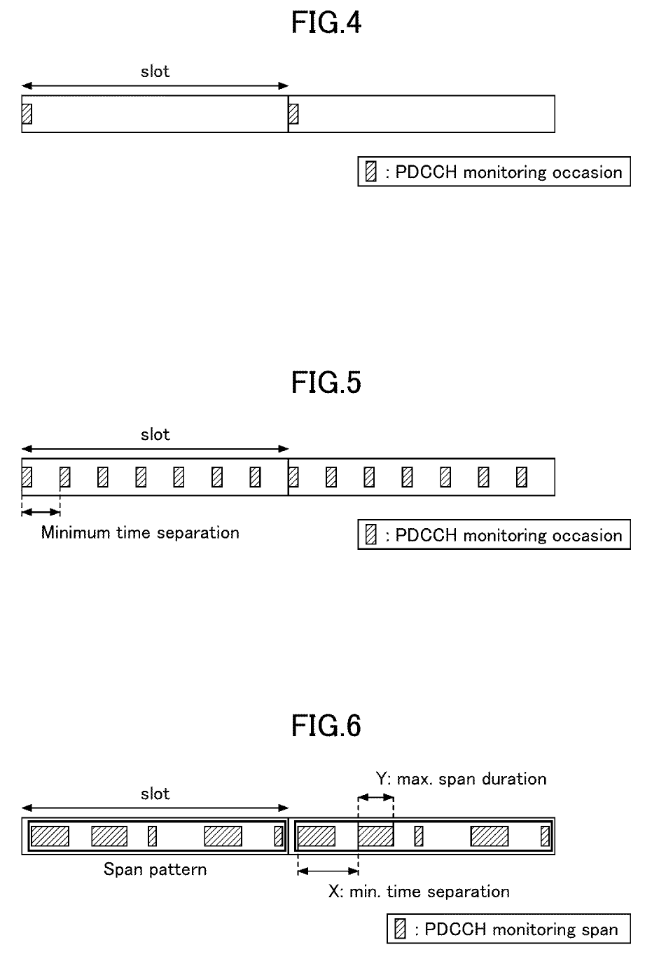

This is a mandatory function that should be supported without a capability signal, and is defined in FG3-1 in the reference document 1. That is, as illustrated in FIG. 4, the terminal 20 must be able to monitor PDCCH by at least one monitoring occasion per one slot. In addition, the PDCCH monitoring period is 14 or more symbols, and the limits of the number of PDCCH candidates/the number of CCEs/the number of BDs are defined for each slot.

(2) A plurality of monitoring occasions per one slot

This is an optional function that requires capability signal transmission, and is defined by pdcchMonitoringAnyOccasionswithDCI-gap in Non-Patent Document 4, FG3-5a in reference document 1, and the like. That is, as illustrated in FIG. 5, the terminal 20 monitors PDCCH by a plurality of monitoring occasions per one slot.

(3) Span level PDCCH monitoring

This is an optional function that requires capability signal transmission, and is defined by pdcchMonitoringAnyOccasionswithDCI-gap in Non-Patent Document 4, FG3-5b/11-2 in reference document 1, and the like. More specifically, in Rel-15, the limits of the number of PDCCH candidates/the number of CCEs/the number of BDs are defined per a slot unit, and in Rel-16, the limits of the number of PDCCH candidates/the number of CCEs/the number of BDs are defined per a span unit for a combination of (X,Y).

The span level PDCCH monitoring will be described with reference to FIG. 6. As illustrated in FIG. 6, one slot is divided into a plurality of time gaps (time separations), and there is a span as a time for monitoring PDCCH in one time gap. In (X,Y), the minimum value of one time gap (gap between spans) is X symbols, and the maximum value of the span in one time gap is Y symbols. (X,Y) may be, for example, (2,2), (4,3), or (7,3). In addition, the span level PDCCH monitoring is defined for all SCSs in FG-3-5b in the reference document 1, and is defined for 15 kHz and 30 kHz in 11-2. The configuration of spans in a slot is referred to as a span pattern.

As described above, in an operation in the high frequency band that is equal to or greater than 52.6 GHz, an SCS, which is larger than that in FR1/FR2 (e.g., 480 kHz, 960 kHz), is assumed to be used, and, accordingly, the symbol length is assumed to become shorter.

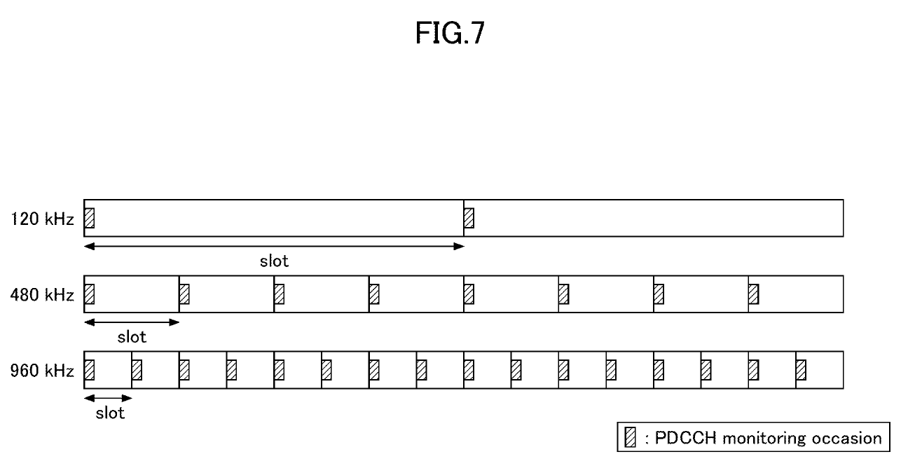

In the terminal capability of the above-described conventional technology, the terminal 20 monitors at least one PDCCH per one slot. However, as illustrated in FIG. 7, the slot length becomes shorter as the SCS becomes larger, and thus, the PDCCH monitoring occasion becomes excessively frequent, and the load and the power consumption of the terminal 20 increase. As a result, the terminal 20 become unable to support the mandatory capability. That is, there is a possibility that the terminal, which supports the conventional definitions that assume the frequency band that is up to 52.6 GHz, cannot appropriately perform monitoring in the high frequency band that is higher than 52.6.

Hereinafter, the technology related to an embodiment of the present invention for solving the above-described problem to be solved will be described.

### Overview of embodiment

In an embodiment of the present invention, the terminal capability, which is related to the downlink control channel as defined in FG3-1 in the reference document 1, need not be required as a mandatory capability. Specifically, what kind of capability is provided to the terminal 20 will be described later in the embodiment 1 and the embodiment 2. The overview is as described below.

The embodiment 1 is an embodiment related to the basic terminal capability related to the downlink control channel, and an example corresponding to modifications/enhancements in FG3-1 in the reference document 1 will be described.

The embodiment 2 is an embodiment related to the PDCCH monitoring occasion, and an example corresponding to modifications/enhancements in FG3-5a, 3-5b, and 11-2 in the reference document 1 will be described. More specifically, an example corresponding to modifications/enhancements of definitions of a case in which the PDCCH monitoring occasion is enabled by any OFDM symbol under the DCI gap will be described. In addition, an example corresponding to modifications/enhancements of definitions of a case in which the PDCCH monitoring occasion is enabled by any OFDM symbol under the span gap will be described.

### Basic operation example

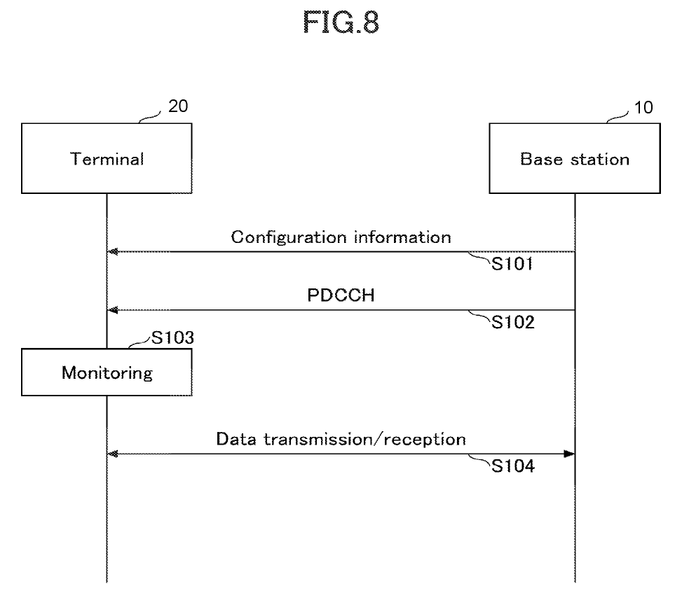

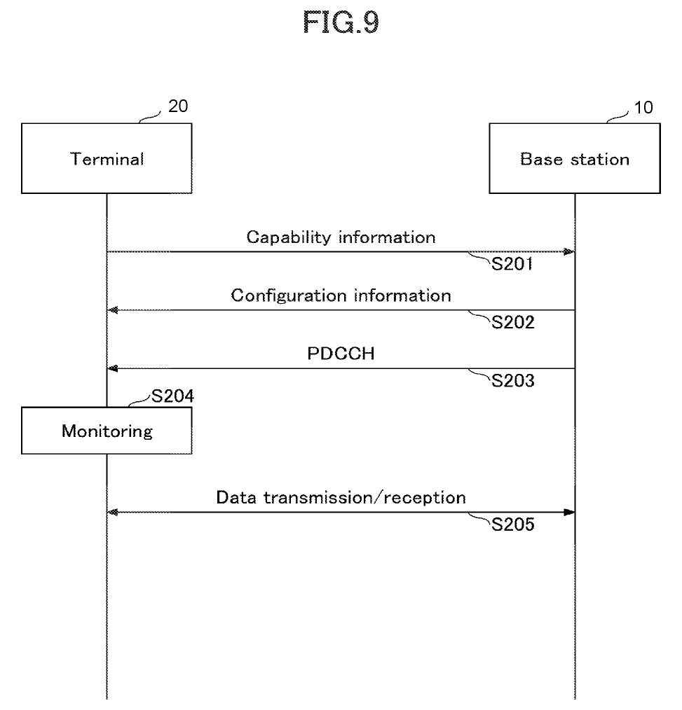

The basic operation example in an embodiment of the present invention common to the embodiment 1 and the embodiment 2 will be described with reference to FIG. 8 and FIG. 9.

In S101 in FIG. 8, the base station 10 transmits configuration information to the terminal 20. The configuration information may be transmitted via any one of RRC signaling, MAC CE, and DCI.

PDCCH is transmitted from the base station 10 (S102). In S103, the terminal 20 performs monitoring of PDCCH, based on the configuration information received in S101. Note that the configuration information from the base station 10 in S101 is not necessarily required. The terminal 20 may perform an operation of PDCCH monitoring, based on the configuration information that is stored in advance (for example, the configuration defined in the specifications).

According to the monitoring in S103, in response to detecting the PDCCH (DCI) addressed to the terminal 20 itself, in S104, the terminal 20 performs data transmission or data reception, based on the information specified by the DCI.

FIG. 9 is an example of a case of indicating capability information. In S201 in FIG. 9, the terminal 20 transmits capability information (UE capability) to the base station 10. In S202, for example, the base station 10 transmits, to the terminal 20, configuration information based on the capability information received in S201. The configuration may be transmitted via any one of RRC signaling, MAC CE, and DCI.

PDCCH is transmitted from the base station 10 (S203). The base station 10 may determine the PDCCH transmission resource, the period, and the like, based on the capability information received in S201.

In S204, the terminal 20 performs PDCCH monitoring, based on the configuration information received in S202. Note that the configuration from the base station 10 in S202 is not necessarily required. The terminal 20 may perform an operation of PDCCH monitoring, based on the configuration information that is stored in advance.

According to the monitoring in S204, in response to detecting the PDCCH (DCI) addressed to the terminal 20 itself, in S205, the terminal 20 performs data transmission or data reception, based on the information specified by the DCI.

### Regarding capability information signaling

As described above, in an embodiment of the present invention, the basic terminal capability (function), which is related to the downlink control channel and defined as mandatory in the conventional technology (e.g., FG3-1 in the reference document 1), need not be required to be mandatory. Accordingly, in an embodiment of the present invention (including the embodiment 1 and the embodiment 2), the terminal 20 may perform indication (signaling) of capability information as described in the following option 1 to option 3 to the base station 10. The indication of the capability information corresponds to S201 in FIG. 9.

### Option 1

In a case where an operation is performed in the high frequency band that is equal to or greater than 52.6 GHz, the terminal 20 reports, to the base station 10, a function that cannot be supported from among the functions in the conventional definitions (e.g., FG3-1 in the reference document 1) via incapability signaling.

### Option 2

In a case where an operation is performed in the high frequency band that is equal to or greater than 52.6 GHz, the terminal 20 reports, to the base station 10, capability information related to the new terminal capability (e.g., capability described in the embodiment 1 and the embodiment 2).

### Option 3

The terminal 20, which performs an operation in the high frequency band that is equal to or greater than 52.6 GHz, supports a new mandatory capability without capability signaling (e.g., capability described in the embodiment 1 and the embodiment 2).

### Embodiment 1

Hereinafter, the embodiment 1 will be described. In the embodiment 1, the terminal 20 performs signal reception in a band of high frequency band that is equal to or greater than 52.6 GHz. Hereinafter, an embodiment 1-1, an embodiment 1-2, an embodiment 1-3, and an embodiment 1-4 will be described. The embodiment 1-1, the embodiment 1-2, the embodiment 1-3, and the embodiment 1-4 may be freely combined to be performed.

### Embodiment 1-1

In the embodiment 1-1, an example related to the component (1) (One configured CORESET per BWP per cell in addition to CORESET0) in the FG3-1 in the reference document 1 will be described.

The terminal 20 in the embodiment 1-1 basically supports a function (capability) of the component (1) in FG3-1 in the reference document 1, and, with respect to the function described below, supports a function that is modified/enhanced from the component (1). Note that this is an example, and the terminal 20 may support the function described below without relationship with the component (1) in 3-1 in the reference document 1.

In the embodiment 1-1, in the band of high frequency band that is higher than 52.6 GHz, the terminal 20 can monitor CORESET of one to three symbols, or a number of symbols of that is greater than 3. Note that the CORESET is a time and frequency area in which the terminal 20 monitors PDCCH.

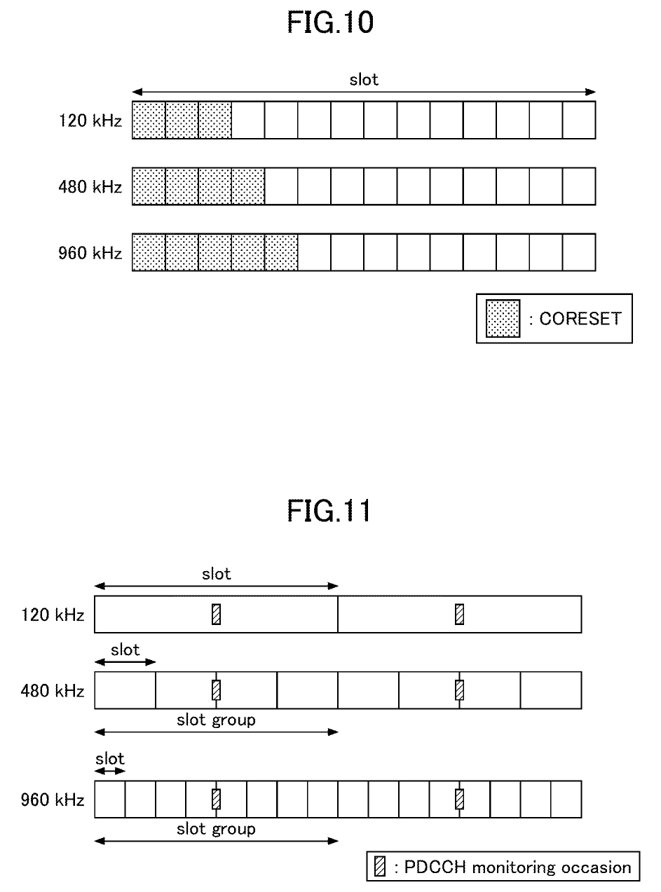

The number of symbols of CORESET that can be monitored may be defined depending on the SCS. For example, in an example illustrated in FIG. 10, in a case where the downlink SCS is 120 kHz, the terminal 20 can monitor one to three symbols of CORESET. In a case where the downlink SCS is 480 kHz, the terminal 20 can monitor one to four symbols of CORESET. In a case where the downlink SCS is 960 kHz, the terminal 20 can monitor one to five symbols of CORESET.

For example, in the sequence illustrated in FIG. 8, the terminal 20 receives, from the base station 10, configuration information including the number of symbols of CORESET to be monitored by the terminal 20. In a case where the SCS=480 kHz, for example, the number of symbols=4 is specified by the configuration information.

The base station 10 transmits PDCCH (DCI) in a range of four symbols of CORESET. In S103, the terminal 20 performs PDCCH monitoring in an area of four symbols of CORESET.

In addition, as illustrated in the sequence in FIG. 9, the capability information may be indicated. That is, as illustrated in FIG. 9, in S201, the terminal 20 indicates, as the capability information to the base station 10, the number of (the maximum number of) symbols of CORESET that can be monitored. For example, in a case where SCS=480 kHz, the terminal 20 indicates, as the number of symbols of CORESET that can be monitored, 4 to the base station 10.

According to the above, the base station 10 can determine that the maximum number of symbols of CORESET that can be monitored by the terminal 20 is 4, and thus, in S202, for example, the base station 10 performs configuration of the number of symbols of CORESET=4 (S202), and performs PDCCH transmission in a range of the number of symbols=4 (S203). Alternatively, PDCCH transmission may be performed in S203 without performing the configuration in S202.

As described above, by increasing the number of symbols of CORESET, the terminal 20 can appropriately monitor PDCCH even in a case where the symbol length becomes shorter as the SCS increases.

Note that the case of increasing the number of symbols of CORESET in accordance with the increase of SCS is an example. The frequency width of CORESET may be increased in accordance with the increase of SCS. In addition, the period of CORESET in the search space may be decreased in accordance with the increase of SCS.

### Embodiment 1-2

In the embodiment 1-2, an example related to the component (2) (CSS and UE-SS configurations for unicast PDCCH transmission per BWP per cell) in the FG3-1 in the reference document 1 will be described.

The terminal 20 in the embodiment 1-2 basically supports a function (capability) of the component (2) in FG3-1 in the reference document 1, and, with respect to the function described below, supports a function that is modified/enhanced from the component (2). Note that this is an example, and the terminal 20 may support the function described below without relationship with the component (2) in 3-1 in the reference document 1.

The embodiment 1-2 can be divided into an embodiment 1-2-1 and an embodiment 1-2-2, and thus, each of the embodiment 1-2-1 and the embodiment 1-2-2 will be described below.

### Embodiment 1-2-1

In the embodiment 1-2-1, in the band higher than 52.6 GHz, the terminal 20 performs PDCCH monitoring by assuming at most an AL (aggregation level) lower than 16. The AL is a number of CCEs (Control Channel Elements) that are allocated to PDCCH to be monitored. That is, the terminal 20 only needs to have a capability of monitoring PDCCH with AL=N (N is a number less than 16).

For example, in a case where SCS is 120 kHz, the terminal 20 monitors PDCCH by assuming that AL is at most 16. In a case where SCS is 480 kHz, the terminal 20 monitors PDCCH by assuming that AL is at most 8. In a case where SCS is 960 kHz, the terminal 20 monitors PDCCH by assuming that AL is at most 4.

For example, in the sequence illustrated in FIG. 8, the terminal 20 receives, from the base station 10, configuration information including the maximum number of AL of PDCCH to be monitored by the terminal 20. In a case where the SCS=480 kHz, for example, AL=8 is specified by the configuration information.

The base station 10 transmits PDCCH (DCI) in a range of AL=8. In S103, the terminal 20 performs monitoring by assuming PDCCH with up to AL=8. For example, the terminal 4 performs monitoring by assuming AL=4 and AL=8.

In addition, as illustrated in the sequence in FIG. 9, the capability information may be indicated. That is, as illustrated in FIG. 9, in S201, the terminal 20 indicates, as the capability information to the base station 10, the maximum number of AL that can be monitored. For example, in a case where SCS=480 kHz, the terminal 20 indicates, as the maximum number of AL that can be monitored, 8 to the base station 10.

According to the above, the base station 10 can determine that the maximum number of AL that can be monitored by the terminal 20 is 8, and thus, in S202, for example, the base station 10 performs transmission of PDCCH that is created in a range of AL=8 (S203). Alternatively, PDCCH transmission may be performed in S203 without performing the configuration in S202.

As described above, by limiting AL to a value smaller than 16, the terminal 20 can efficiently monitor PDCCH in the band higher than 52.6 GHz.

### Embodiment 1-2-2

In the embodiment 1-2-2, in the band higher than 52.6 GHz, the number of symbols in the PDCCH monitoring occasion of the terminal 20 and the positions of the PDCCH monitoring occasions are not limited to specific values. For example, the PDCCH monitoring occasions may be one or more symbols in the center of a slot, or may be one or more symbols at the boundary part of two slots in a slot group (a set of two or more slots).

FIG. 11 illustrates an example of PDCCH monitoring occasion by the terminal 20. In the example of FIG. 11, in a case where SCS=120 kHz, the terminal 20 performs PDCCH monitoring with one or more symbols at the center of a slot. In a case where SCS=480 kHz, the terminal 20 performs PDCCH monitoring with one or more symbols at the boundary part of two slots (a part across the two slots) in a slot group including four slots. In a case where SCS=960 kHz, the terminal 20 performs PDCCH monitoring with one or more symbols at the boundary part of two slots (a part across the two slots) in a slot group including eight slots.

For example, in the sequence illustrated in FIG. 8, the terminal 20 receives, from the base station 10, configuration information of PDCCH monitoring occasions by the terminal 20. The configuration information may include, for example, one of, or a plurality of, or all of: the number of symbols per one PDCCH monitoring occasion; the period of the PDCCH monitoring occasion; and the position of the PDCCH monitoring occasion (the center of a slot, boundary of two slots, etc.).

In a case where the base station 10 transmits PDCCH addressed to the terminal 20, the base station 10 may perform transmission in the above-described PDCCH monitoring occasion. In S103, the terminal 20 performs monitoring in the monitoring occasion configured in S101.

In addition, as illustrated in the sequence in FIG. 9, the capability information may be indicated. For example, in S201, the terminal 20 indicates, as the capability information to the base station 10, one of, or a plurality of, or all of: the number of symbols per one PDCCH monitoring occasion; the period of the PDCCH monitoring occasion; and the position of the PDCCH monitoring occasion (the center of a slot, boundary of two slots, etc.), that are supported by the terminal 20 itself.

According to the above, the base station 10 can determine the PDCCH monitoring occasion that can be monitored by the terminal 20, and thus, in S202, the base station 10 can perform configuration by taking the PDCCH monitoring occasion into account. Alternatively, PDCCH transmission may be performed in S203 without performing the configuration in S202.

As described above, the terminal 20 can appropriately monitor PDCCH even in a case where the symbol length becomes shorter as the SCS increases, because the number of symbols and the position can be freely configured as the PDCCH monitoring occasion.

### Embodiment 1-3

In the embodiment 1-3, an example related to the component (4) (Number of PDCCH blind decodes per slot with a given SCS follows Case 1-1 table) in the FG3-1 in the reference document 1 will be described.

The terminal 20 in the embodiment 1-3 basically supports a function (capability) of the component (4) in FG3-1 in the reference document 1, and, with respect to the function described below, supports a function that is modified/enhanced from the component (4). Note that this is an example, and the terminal 20 may support the function described below without relationship with the component (4) in 3-1 in the reference document 1.

In the embodiment 1-3, in a case where an SCS is used that is larger than SCS=120 kHz in the band higher than 52.6 GHz, the terminal 20 may perform PDCCH monitoring with at most the number of BDs (may be referred to as the number of PDCCH candidates) that is the same as the number specified for SCS=120 kHz, or with the number of BDs that is smaller than the specified number of BDs.

The maximum number of BDs to be applied by the terminal 20 may be a number per slot, may be a number per sub-slot, may be a number per slot group, may be a number per subframe, or may be number per another unit. Note that the sub-slot is a unit of time length that is smaller than one slot, and the subframe is a unit of time length smaller than one frame.

Which per unit is to be applied to maximum number of BDs may be defined by the specifications, or may be configured by the configuration information from the base station 10 to the terminal 20.

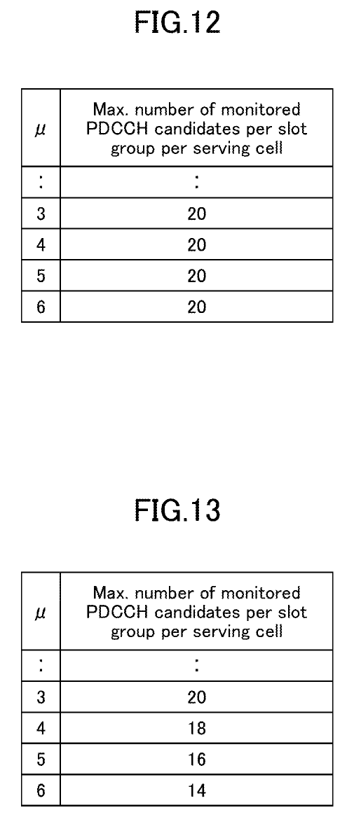

In addition, for example, the tables illustrated in FIG. 12 or FIG. 13 may be defined in the specifications, etc., and the terminal 20 may perform monitoring with the maximum number of BDs conforming to the definition of the table. In addition, the configuration information of the maximum number of BDs conforming to the definition of the table illustrated in FIG. 12 or FIG. 13 may be indicated from the base station 10 to the terminal 20, and the terminal 20 may perform monitoring with the maximum number of BDs conforming to the configuration information. In addition, in a case where the terminal 20 have a capability of the maximum number of BDs conforming to the table illustrated in FIG. 12 or FIG. 13, the terminal 20 may indicate the maximum number of BDs as the capability information to the base station 10.

In FIG. 12 and FIG. 13, as an example, the maximum number of BDs per SCS per slot group is illustrated. In an example of FIG. 12, the number of BDs for μ=3 (SCS=120 kHz) is 20, and the same number 20 is also defined for μ=4, 5, 6 (SCS=240, 480, 960 kHz).

In an example of FIG. 13, the number of BDs for μ=3 (SCS=120 kHz) is 20, and 18, 16, and 14, which are smaller than 20, are defined as the numbers of BDs for μ=4, 5, 6 (SCS=240, 480, 960 kHz), respectively.

For example, in the sequence illustrated in FIG. 8, the terminal 20 receives, from the base station 10, configuration information including the maximum number of BDs to be applied to the monitoring by the terminal 20. In a case where the SCS=480 kHz, for example, the number of BDs per slot group=16 is specified by the configuration information. In addition, the number of slots in one slot group may be specified by the configuration information.

The base station 10 transmits PDCCH (DCI). In S103, the terminal 20 performs monitoring of PDCCH with the maximum number of BDs=16, based on the configuration information, for example.

In addition, as illustrated in the sequence in FIG. 9, the capability information may be indicated. That is, as illustrated in FIG. 9, in S201, the terminal 20 indicates, as the capability information to the base station 10, the maximum number of BDs (and the unit such as the slot group, and the like) supported by the terminal 20 itself.

According to the above, the base station 10 can determine that the maximum number of BDs that can be monitored by the terminal 20, and thus, in S202, for example, the base station 10 performs configuration of the maximum number of BDs (S202), and performs PDCCH transmission (S203). Alternatively, PDCCH transmission may be performed in S203 without performing the configuration in S202.

As described above, by decreasing the maximum number of BDs, and by adjusting the unit, the terminal 20 can appropriately monitor PDCCH even in a case where the symbol length or the slot length becomes shorter as the SCS increases.

### Embodiment 1-4

In the embodiment 1-4, an example related to the component (5) (Processing one unicast DCI scheduling DL and one unicast DCI scheduling UL per slot per scheduled CC for FDD) and the component (6) (Processing one unicast DCI scheduling DL and 2 unicast DCI scheduling UL per slot per scheduled CC for TDD) in FIGS. 3-1 in the reference document 1 will be described.

The terminal 20 in the embodiment 1-4 basically supports a function (capability) of the components (5) and (6) in FIGS. 3-1 in the reference document 1, and, with respect to the function described below, supports a function that is modified/enhanced from the components (5) and (6). Note that this is an example, and the terminal 20 may support the function described below without relationship with the components (5) and (6) in 3-1 in the reference document 1.

In the embodiment 1-4, the maximum number of DCIs that can be processed by the terminal 20 is defined per scheduled CC per slot or symbol group or sub-slot or slot group or subframe or span for combination (X,Y). The DCIs are, for example, but not limited to, unicast DCIs for scheduling DL or UL. In addition, the above-described number of DCIs may be defined for each of TDD and FDD.

The maximum number of DCIs that can be processed for each unit (slot, symbol group, sub-slot, slot group, subframe, span, or the like), may be defined by the specifications, or may be configured by the configuration information from the base station 10 to the terminal 20. In addition, the terminal 20 may indicate, as the capability information to the base station 10, the maximum number of DCIs that can be processed, together with the unit (slot, symbol group, sub-slot, slot group, subframe, span, or the like).

In addition, the above-described unit information (for example, the number of slots included in a slot group) for each SCS may be defined by the specifications, or may be configured by the configuration information from the base station 10 to the terminal 20. In addition, the unit information (for example, the number of slots included in a slot group, which can be supported by the terminal 20) may be indicated as the capability information from the terminal 20 to the base station 10.

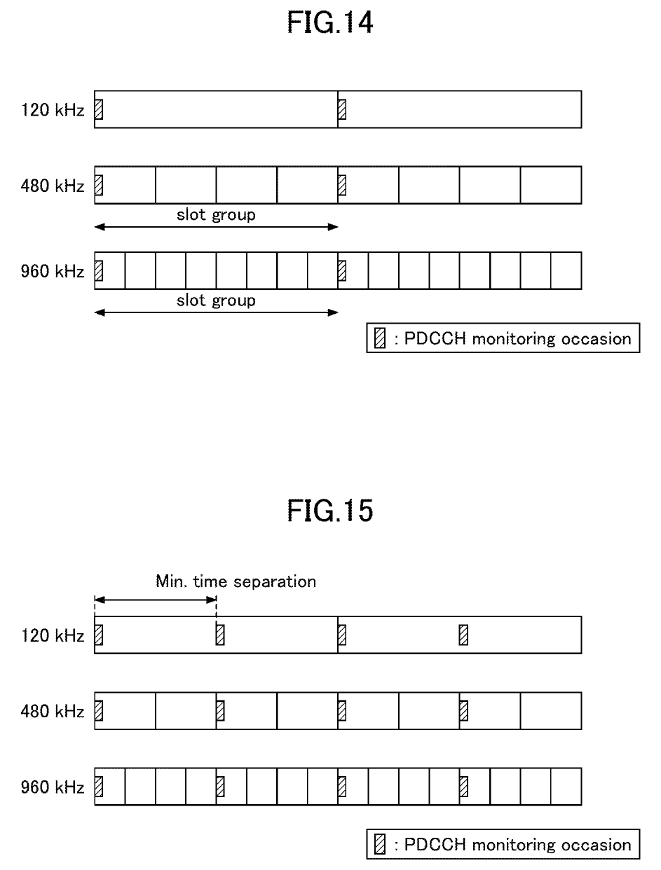

FIG. 14 is a drawing illustrating an example of a slot group as the above-described unit. In an example of FIG. 14, the slot group is defined in such a way that the slot group length in a case where SCS=480 kHz and 960 kHz becomes the same as the slot length in a case where SCS=120 kHz.

For example, in the sequence illustrated in FIG. 8, the terminal 20 receives, from the base station 10, configuration information including: the maximum number of DCIs to be processed by the terminal 20; the unit; and the unit information thereof. In a case where the SCS=480 kHz, for example, the number of DCIs per slot group=3, and the slot group=4 slots, are specified by the configuration information.

The base station 10 transmits PDCCH (DCI). In S103, the terminal 20 performs DCI processing with a condition that the number of DCIs per slot group=3. The DCI processing is, for example, decoding DCI and reading the DCI information.

In addition, as illustrated in the sequence in FIG. 9, the capability information may be indicated. That is, as illustrated in FIG. 9, in S201, the terminal 20 indicates, as the capability information to the base station 10, the maximum number of DCIs, which is supported by the terminal 20 itself.

According to the above, the base station 10 can determine that the maximum number of DCIs that can be processed by the terminal 20, and thus, in S202, for example, the base station 10 performs configuration of the maximum number of DCIs (S202), and performs PDCCH transmission (S203). Alternatively, PDCCH transmission may be performed in S203 without performing the configuration in S202.

In addition, as an example, the terminal 20 may only need to be able to process at most one DCI per one slot group of one CC in TDD (or FDD). The terminal 20 may indicate this capability to the base station 10, or this capability may be specified in the specifications and the terminal 20 may operate according to the specifications.

As described above, for example, the number per slot group unit is enabled to be used as the maximum number of DCIs that can be processed by the terminal 20, and thus, the terminal 20 can appropriately perform DCI processing even in a case where the symbol length or the slot length becomes shorter as the SCS increases.

### Other examples in the embodiment 1

The operations described in the embodiments 1-1 and 1-2 may be defined per type of search space (e.g., CSS, USS), or may be defined per SCS.

In addition, the indication of the capability information from the terminal 20 to the base station 10 as described in the embodiments 1-1 and 1-2 may be performed for each of the functions described in the embodiments 1-1 and 1-2, or may be performed by a single capability information indication including all of the functions described in the embodiments 1-1 and 1-2. With respect to the above point, the same point is applied to embodiments 2-1 to 2-4 described below.

### Embodiment 2

Hereinafter, the embodiment 2 will be described. It is assumed that the terminal 20 performs signal reception in the high frequency band that is equal to or greater than 52.6 GHz also in the embodiment 2. Hereinafter, an embodiment 2-1, an embodiment 2-2, an embodiment 2-3, and an embodiment 2-4 will be described. The embodiment 2-1, the embodiment 2-2, the embodiment 2-3, and the embodiment 2-4 may be freely combined to be performed.

Note that, in the embodiment 2, an example related to FG3-5a, 3-5b, and 11-2 in the reference document 1 will be described. The terminal 20 in the embodiment 2 basically supports a function (capability) of FG3-5a, 3-5b, and 11-2 in the reference document 1, and, with respect to the function described below, supports a function that is modified/enhanced from FG3-5a, 3-5b, and 11-2 in the reference document 1. Note that this is an example, and the terminal 20 may support the function described below without relationship with FG3-5a, 3-5b, and 11-2 in the reference document 1.

### Embodiment 2-1

In the embodiment 2-1, the PDCCH monitoring occasion in the terminal 20 may be one or more symbols at freely determined positions in a slot group. There is provided a time gap (DCI gap, time gap between two DCIs) between a PDCCH monitoring occasion and the subsequent PDCCH monitoring occasion.

In particular, in the embodiment 2-1, in a case where an SCS that is larger than 120 kHz is used, the minimum value of the above-described time gap (DCI gap) is configured to the terminal 20. The unit of the minimum value is not limited to a specific unit, and may be, for example, a symbol, a sub-slot, a slot, or a subframe.

The minimum value of the above-described time gap in the terminal 20 may be defined together with the unit in the specifications, and need not be indicated to the base station 10 as the capability information supported by the terminal 20. In addition, the minimum value of the above-described time gap in the terminal 20 may be indicated to the base station 10 together with the unit as the capability information supported by the terminal 20.

As an example, the above-described minimum value of the time gap may be 11 symbols in a case where SCS=120 kHz, may be 16 symbols in a case where SCS=480 kHz, and may be 21 symbols in a case where SCS=960 kHz.

FIG. 15 illustrates an example of the minimum value of the time gap between the PDCCH monitoring occasions. FIG. 15 shows an example in which one block in each SCS represents one slot. In addition, one slot group=2 slots in a case where SCS=480 kHz, and one slot group=4 slots in a case where SCS=960 kHz.

In an example of FIG. 15, the minimum value of the time gap in a case where SCS=120 kHz is one slot, and the minimum value of the time gap in a case where SCS=480 kHz, and 960 kHz is one slot group.

In addition, as described in the embodiment 1-2, the PDCCH monitoring occasion may be located across the slot boundary.

For example, in the sequence illustrated in FIG. 8, the terminal 20 receives, from the base station 10, configuration information including: the time gap to be applied to the monitoring by the terminal 20; and the unit information thereof. The time gap is a value equal to or greater than the minimum time gap described above.

For example, the base station 10 may transmit PDCCH (DCI) with the time gap configured to the terminal 20. In S103, for example, the terminal 20 performs monitoring of PDCCH with the time gap specified by the configuration information.

In addition, as illustrated in the sequence in FIG. 9, the capability information may be indicated. That is, as illustrated in FIG. 9, in S201, the terminal 20 indicates, as the capability information to the base station 10, the minimum time gap and the unit, which are supported by the terminal 20 itself. The time gap is, for example, a value of the minimum time gap described above.

According to the above, the base station 10 can determine the minimum time gap that can be monitored by the terminal 20, and thus, in S202, for example, the base station 10 performs configuration of the time gap with a value equal to or greater than the minimum time gap (S202), and performs PDCCH transmission (S203). Alternatively, PDCCH transmission may be performed in S203 without performing the configuration in S202.

As described above, for example, not only the number per slot, but also the number per slot group, is enabled to be used as the time gap of the monitoring that can be performed by the terminal 20, and thus, the terminal 20 can appropriately perform PDCCH monitoring processing in a case where the symbol length becomes shorter as the SCS increases.

### Embodiment 2-2

The embodiment 2-2 assumes the embodiment 2-1. Note that the embodiment 2-2 need not assume the embodiment 2-1. The unit (time unit) in the limitation of PDCCH processing in the terminal 20 may be, not only a slot, but also a slot group or a subframe.

For example, as described in the embodiment 1-3, in a case where an SCS is used that is larger than SCS=120 kHz in the band higher than 52.6 GHz, the terminal 20 may perform PDCCH monitoring with at most the number of BDs (may be referred to as the number of PDCCH candidates): of the same number as is specified in a case where SCS=120 kHz; or of a number that is less than the above-described number of the BDs. Specifically, the values illustrated in FIG. 12 and FIG. 13 in the embodiment 1-3 may be applied.

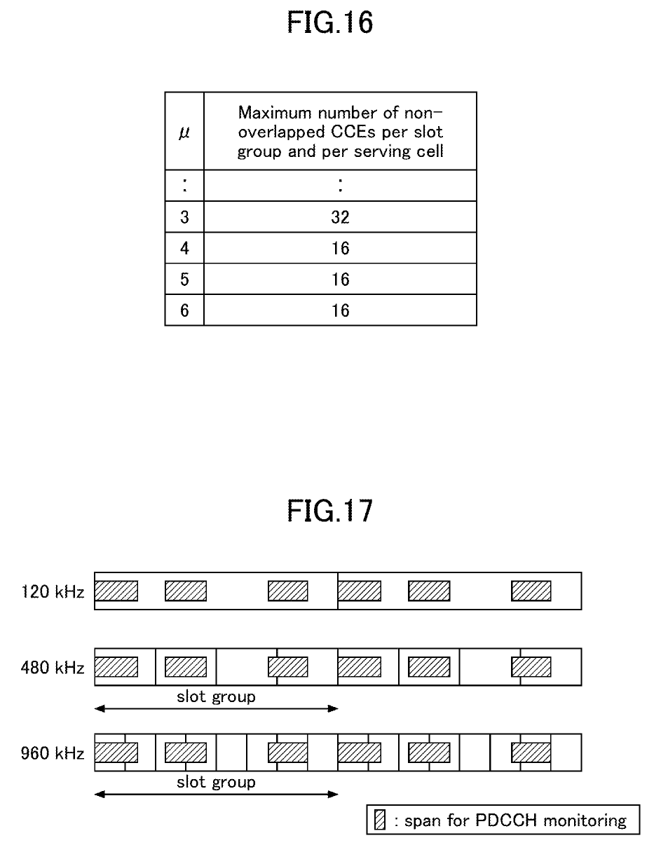

In addition, for example, the table illustrated in FIG. 16 may be defined in the specifications, and the terminal 20 may perform monitoring with the maximum number of CCEs per slot group conforming to the definition of the table. In addition, the configuration information of the maximum number of CCEs conforming to the definition of the table illustrated in FIG. 16 may be indicated from the base station 10 to the terminal 20, and the terminal 20 may perform monitoring with the maximum number of CCEs conforming to the configuration information. In addition, in a case where the terminal 20 have a capability of the maximum number of CCEs conforming to the table illustrated in FIG. 16, the terminal 20 may indicate the maximum number of CCEs as the capability information to the base station 10.

In FIG. 16, as an example, the maximum number of CCEs per SCS per slot group is illustrated. In an example of FIG. 16, the number of CCEs=32 in a case where μ=3 (SCS=120 kHz), the number of CCEs=16 in a case where μ=4 (SCS=240 kHz), the number of CCEs=16 in a case where μ=5 (SCS=480 kHz), and the number of CCEs=16 in a case where μ=6 (SCS=960 kHz), are specified.

The limit value of the monitoring, regardless of the above-described example, may be indicated from the terminal 20 to the base station 10 as the capability information, may be configured from the base station 10 to the terminal 20 via RRC signaling (may be via MAC CE or DCI), or may be specified in the specifications, or the like.

For example, in the sequence illustrated in FIG. 8, the terminal 20 receives, from the base station 10, configuration information including: the limit value to be applied to the monitoring by the terminal 20 (e.g., the maximum number of BDs, the maximum number of CCEs); and the unit information thereof.

The base station 10 transmits PDCCH (DCI). In S103, for example, the terminal 20 performs monitoring of PDCCH with a range of the limit value specified by the configuration information.

In addition, as illustrated in the sequence in FIG. 9, the capability information may be indicated. That is, as illustrated in FIG. 9, in S201, the terminal 20 indicates, as the capability information to the base station 10, capability of the limit value that is supported by the terminal 20 itself and the unit thereof.

According to the above, the base station 10 performs the configuration (S202) by taking the limit value that can be applied to the terminal 20 into account in S202, and performs PDCCH transmission (S203). Alternatively, PDCCH transmission may be performed in S203 without performing the configuration in S202.

As described above, for example, not only a value per slot, but also a value per slot group, is enabled to be used as the limit value of the PDCCH monitoring by the terminal 20, and thus, the terminal 20 can appropriately perform PDCCH monitoring processing in a case where the symbol length becomes shorter as the SCS increases.

### Other examples in the embodiments 2-1 and 2-2

The operations described in the embodiments 2-1 and 2-2 may be defined per type of search space (e.g., CSS, USS), or may be defined per SCS.

### Embodiment 2-3

In the embodiment 2-3, the PDCCH monitoring occasion in the terminal 20 may be one or more symbols at freely determined positions in a slot (or a slot group). There is provided a time gap (may be referred to as a span gap or a span interval) between a PDCCH monitoring occasion (here, may be also referred to as a span) and the subsequent PDCCH monitoring occasion (span). Note that, with respect to a method using a span, refer to the descriptions that have been made with reference to FIG. 6. In addition, the span gap (span interval) between the span A and the span B is a time gap from the beginning of the span A to the beginning of the span B.

In particular, in the embodiment 2-3, in a case where an SCS that is larger than 120 kHz is used, the minimum value X of the above-described time gap (span gap) and the span length Y are configured to the terminal 20. The unit of the minimum value X is not limited to a specific unit, but may be a symbol, for example. In this case, the number of symbols, X is configured as the minimum value. In addition, the unit of the span length is not limited to a specific unit, but may be a symbol, for example. In this case, the number of symbols (the number of consecutive symbols), Y is configured as the span length.

This is an example. The unit of X and Y may be, other than the symbol, a sub-slot, a slot, or a subframe. In addition, the span may be located across the slot boundary.

X and Y in the terminal 20 may be defined together with the unit thereof in the specifications, and need not be indicated to the base station 10 as the capability information supported by the terminal 20. In addition, X and Y in the terminal 20 may be indicated to the base station 10 together with the unit thereof as the capability information supported by the terminal 20.

As an example, with respect to (X,Y) using a unit of a symbol, one of (8,8), (16,12), and (28,12) may be used in a case where SCS=480 kHz, and one of (16,16), (32,24), and (56,24) may be used in a case where SCS=960 kHz.

The span pattern illustrated in FIG. 6 is defined by using a slot unit. However, in the embodiment 2-3, the span pattern may be defined by using a unit of: sub-slot; slot; slot group; subframe; or frame, and may be repeated by using the unit. FIG. 17 illustrates an example in which the span pattern is defined by using the slot group unit.

For example, in the sequence illustrated in FIG. 8, the terminal 20 receives, from the base station 10, configuration information including (X,Y) to be applied to the monitoring by the terminal 20 and the information of the span pattern. Note that (X,Y) may be included in the information of the span pattern. In addition, in a case where the span pattern that is defined in advance is used, the information of the span pattern need not be included.

For example, the base station 10 transmits PDCCH (DCI) by taking (X,Y) that is configured to the terminal 20 into account. In S103, for example, the terminal 20 performs PDCCH monitoring by using (X,Y) that is specified by the configuration information.

In addition, as illustrated in the sequence in FIG. 9, the capability information may be indicated. That is, as illustrated in FIG. 9, in S201, the terminal 20 transmits capability information including (X,Y) that is supported by the terminal 20 itself and the information of the span pattern to the base station 10. Note that (X,Y) may be included in the information of the span pattern. In addition, in a case where the span pattern that is defined in advance is used, the information of the span pattern need not be included in the capability information.

According to the above, the base station 10 can determine that the information of the span that can be monitored by the terminal 20, and thus, in S202, for example, the base station 10 performs configuration with a range that can be supported by the terminal 20 (S202), and performs PDCCH transmission (S203). Alternatively, PDCCH transmission may be performed in S203 without performing the configuration in S202.

As described above, a value that is longer than the conventional value is enabled to be used as the span or the span gap of the monitoring that can be performed by the terminal 20, and thus, the terminal 20 can appropriately perform PDCCH monitoring processing in a case where the symbol length becomes shorter as the SCS increases.

Note that using a value that is longer than the conventional value as the span or the span gap of the monitoring that can be performed by the terminal 20, is an example. A value that is shorter than the conventional value may also be used as the span Y or the span gap X, in accordance with the selection of a unit used for the span or the span gap.

### Embodiment 2-4

The embodiment 2-4 assumes the embodiment 2-3. Note that the embodiment 2-4 need not assume the embodiment 2-3. The unit (time unit) in the limitation of PDCCH processing in the terminal 20 may be, not only a slot, but also a slot group, a subframe, or a span with (X,Y).

For example, as described in the embodiment 1-3, in a case where an SCS is used that is larger than SCS=120 kHz in the band higher than 52.6 GHz, the terminal 20 may perform PDCCH monitoring with at most the number of BDs (may be referred to as the number of PDCCH candidates): of the same number as is specified in a case where SCS=120 kHz; or of a number that is less than the above-described number of the BDs. Specifically, the values illustrated in FIG. 12 and FIG. 13 in the embodiment 1-3 may be applied.

In addition, for example, the table illustrated in FIG. 16 may be defined in the specifications, and the terminal 20 may perform monitoring with the maximum number of CCEs per slot group conforming to the definition of the table. The configuration information of the maximum number of CCEs conforming to the definition of the table illustrated in FIG. 16 may be indicated from the base station 10 to the terminal 20, and the terminal 20 may perform monitoring with the maximum number of CCEs conforming to the configuration information. In addition, in a case where the terminal 20 have a capability of the maximum number of CCEs conforming to the table illustrated in FIG. 16, the terminal 20 may indicate the maximum number of CCEs as the capability information to the base station 10. The contents of FIG. 16 are as described in the embodiment 2-3.

The limit value of the monitoring, regardless of the above-described example, may be indicated from the terminal 20 to the base station 10 as the capability information, may be configured from the base station 10 to the terminal 20 via RRC signaling (may be via MAC CE or DCI), or may be specified in the specifications, or the like.

For example, in the sequence illustrated in FIG. 8, the terminal 20 receives, from the base station 10, configuration information including: the limit value to be applied to the monitoring by the terminal 20 (e.g., the maximum number of BDs, the maximum number of CCEs); and the unit information thereof.

The base station 10 transmits PDCCH (DCI). In S103, for example, the terminal 20 performs monitoring of PDCCH with a range of the limit value specified by the configuration information.

In addition, as illustrated in the sequence in FIG. 9, the capability information may be indicated. That is, as illustrated in FIG. 9, in S201, the terminal 20 indicates, as the capability information to the base station 10, capability of the limit value that is supported by the terminal 20 itself and the unit thereof.

According to the above, the base station 10 performs the configuration (S202) by taking the limit value that can be applied to the terminal 20 into account in S202, and performs PDCCH transmission (S203). Alternatively, PDCCH transmission may be performed in S203 without performing the configuration in S202.

As described above, for example, not only a value per slot, but also a value per slot group, is enabled to be used as the limit value of the PDCCH monitoring by the terminal 20, and thus, the terminal 20 can appropriately perform PDCCH monitoring processing in a case where the symbol length becomes shorter as the SCS increases.

### Other examples in the embodiments 2-3 and 2-4

The operations described in the embodiments 2-3 and 2-4 may be defined per type of search space (e.g., CSS, USS), or may be defined per SCS.

### Other examples common to the embodiment 1 and the embodiment 2

Any function (capability) of the terminal 20 described in the embodiments 1 and 2, may be applied only to the common search space (CSS), may be applied only to the UE-specific search space (USS), or may be applied both to the common search space (CSS) and the UE-specific search space (USS). In addition, which type of function is to be applied to which type of search space, may be configured from the base station 10 to the terminal 20.

In addition, the control channel for monitoring by the terminal 20 is not limited to the downlink control channel (PDCCH), but may be the sidelink control channel (PSCCH), the downlink feedback channel, or the sidelink feedback channel, for example.

### Apparatus configuration

Next, a functional configuration example of the base station 10 and the terminal 20 for performing the processes and operations described above will be described.

### Base station 10

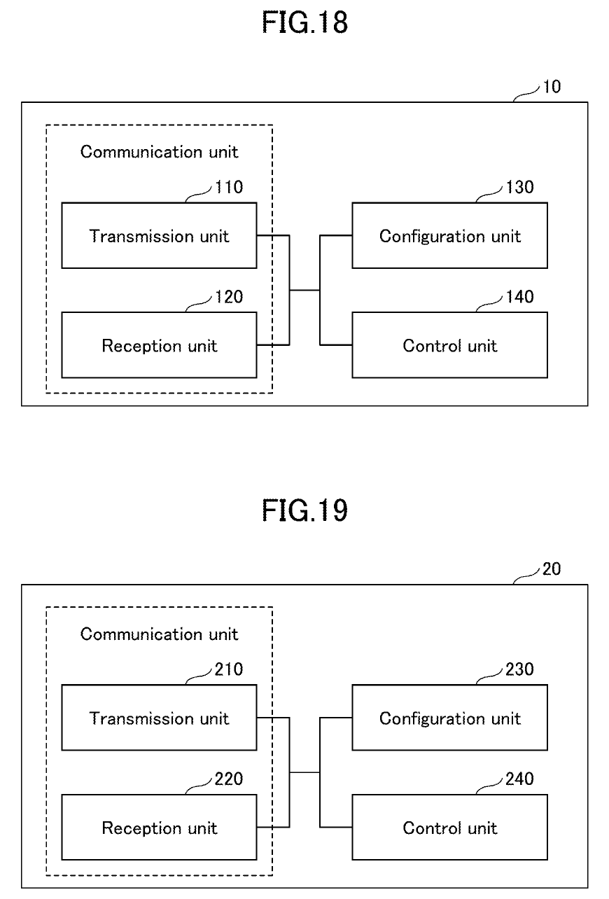

FIG. 18 is a diagram illustrating an example of a functional configuration of the base station 10. As shown in FIG. 18, the base station 10 includes a transmission unit 110, a reception unit 120, a configuration unit 130, and a control unit 140. The functional structure illustrated in FIG. 18 is merely an example. Functional divisions and names of functional units may be anything as long as operations according to an embodiment of the present invention can be performed. Further, the transmission unit 110 and the reception unit 120 may be combined and may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, DCI via PDCCH, data via PDSCH, and the like, to the terminal 20.

The configuration unit 130 stores preset configuration information and various configuration information items to be transmitted to the terminal 20 in a storage device included in the configuration unit 130 and reads the preset configuration information from the storage apparatus if necessary.

The control unit 140 performs scheduling of the terminal 20 for DL reception or UL transmission, via the transmission unit 110. In addition, the control unit 140 includes a function of performing LBT. The functional units related to signal transmission in the control unit 140 may be included in the transmission unit 110, and the functional units related to signal reception in the control unit 140 may be included in the reception unit 120. Further, the transmission unit 110 may be referred to as a transmitter, and the reception unit 120 may be referred to as a receiver.

### Terminal 20

FIG. 19 is a diagram illustrating an example of a functional configuration of the terminal 20. As shown in FIG. 19, the terminal 20 includes a transmission unit 210, a reception unit 220, a configuration unit 230, and a control unit 240. The functional structure illustrated in FIG. 19 is merely an example. Functional divisions and names of functional units may be anything as long as operations according to an embodiment of the present invention can be performed. the transmission unit 210 and the reception unit 220 may be combined and may be referred to as a communication unit.

The transmission unit 210 generates a transmission signal from transmission data and transmits the transmission signal wirelessly. The reception unit 220 receives various signals wirelessly and obtains upper layer signals from the received physical layer signals. In addition, the reception unit 220 has a function of receiving NR-PSS, NR-SSS, NR-PBCH, DL/UL/SL control signals, DCI via PDCCH, data via PDSCH, etc., transmitted from the base station 10. In addition, for example, with respect to the D2D communications, the transmission unit 210 may transmit, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 120 may receive, from the another terminal 20, PSCCH, PSSCH, PSDCH, or PSBCH.

The configuration unit 230 stores various configuration information items received from the base station 10 or the another terminal by the reception unit 220 in the storage device included in the configuration unit 230, and reads them from the storage device as necessary. In addition, the configuration unit 230 also stores pre-configured configuration information.

The control unit 240 controls the terminal 20. In addition, the control unit 240 performs monitoring control described in the embodiments 1 and 2. In addition, the control unit 240 includes a function of performing LBT. The functional units related to signal transmission in the control unit 240 may be included in the transmission unit 210, and the functional units related to signal reception in the control unit 240 may be included in the reception unit 220. Further, the transmission unit 210 may be referred to as a transmitter, and the reception unit 220 may be referred to as a receiver.

### Summary

According to an embodiment of the present invention, at least a terminal and a base station as described in the following 1st item to 6th item are provided.

(1st item)

A terminal including:

a control unit configured to perform monitoring of a control channel in an area in which, in a case where a certain SCS is used, a number of symbols is greater than a number of symbols corresponding to another SCS that is less than the certain SCS; and

a reception unit configured to receive control information via the control channel.

(2nd item)

The terminal as described in the 1st item, wherein

the control unit performs the monitoring in a central part of a slot, or in a border part between two slots.

(3rd item)

A terminal including:

a control unit configured to perform monitoring of a control channel at a time gap that is equal to or greater than a minimum value in a case of using an SCS greater than a certain SCS; and

a reception unit configured to receive control information via the control channel.

(4th item)

A terminal including:

a control unit configured to perform monitoring of a control channel in a case of using a second SCS that is greater than a first SCS, by using: a span of a number of symbols that is greater than a number of symbols of a span corresponding to the first SCS; and a span gap of a number of symbols that is greater than a number of symbols of a span gap corresponding to the first SCS; and

a reception unit configured to receive control information via the control channel.

(5th item)

The terminal as described in any one of the 1st item to the 4th item, wherein

in a case of using a certain SCS, the control unit performs the monitoring in a range of a limit value: that is same as a limit value corresponding to an SCS that is less than the certain SCS; or that is less than the limit value.

(6th item)

A base station including:

a reception unit configured to receive, from a terminal, capability information related to a capability of monitoring of a control channel in an area in which, in a case of using a certain SCS, a number of symbols is greater than a number of symbols corresponding to another SCS that is less than the certain SCS; and

a transmission unit configured to transmit configuration information to the terminal, based on the capability information.

According to any one of the 1st item to the 6th item, a technique is provided which enables a terminal to perform appropriate monitoring of a control channel in the high frequency band in a wireless communication system. In particular, according to the 2nd item, the time position of the monitoring occasion can be flexibly configured, and, as a result, the monitoring can be performed appropriately. According to the 5th item, in a case where the SCS becomes larger, the relaxed limit value can be applied, and, as a result, the monitoring can be performed appropriately.

### Hardware structure

In the above functional structure diagrams used for describing an embodiment of the present invention (FIG. 18 and FIG. 19), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

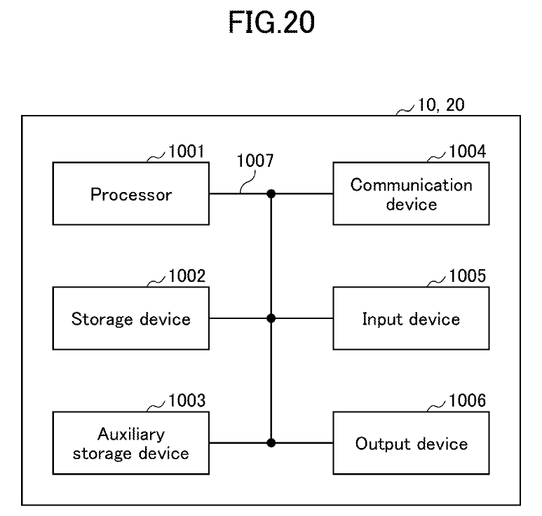

For example, the base station 10, terminal 20, etc., according to an embodiment of the present disclosure may function as a computer for processing the radio communication method of the present disclosure. FIG. 20 is a drawing illustrating an example of hardware structures of the base station 10 and terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term "apparatus" can be read as a circuit, a device, a unit, etc. The hardware structures of the base station 10 and terminal 20 may include one or more of each of the devices illustrated in the figure, or may not include some devices.

Each function in the base station 10 and terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 18 may be realized by control programs that are stored in the storage device 1002 and are executed by the processor 1001. Further, for example, the control unit 240 of the terminal 20 illustrated in FIG. 19 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission and reception device) for communicating with computers via at least one of a wired network and a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

### Supplement of embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms "system" and "network" are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms "BS: Base Station", "Radio Base Station", "Base Station", "Fixed Station", "NodeB", "eNodeB (eNB)", "gNodeB (gNB)", "Access Point", "Transmission Point", "Reception Point", "Transmission/Reception Point", "Cell", "Sector", "Cell Group", "Carrier", "Component Carrier", and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term "cell" or "sector" refers to a part or all of the coverage area of at least one of the base station and base station subsystem that provides communication services at the coverage.

In the present disclosure, terms such as "mobile station (MS)", "user terminal", "user equipment (UE)", "terminal", and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the terminal. For example, each aspect/embodiment of the present disclosure may be applied to a configuration in which communications between the base station and the terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases "up" and "down" may also be replaced by the phrases corresponding to terminal-to-terminal communication (e.g., "side"). For example, an uplink channel, a downlink channel, or the like, may be read as a sidelink channel.

Similarly, the terminal in the present disclosure may be read as the base station. In this case, the function of the terminal described above may be provided by the base station.

The term "determining" used in the present specification may include various actions or operations. The "determining" may include, for example, a case in which "judging", "calculating", "computing", "processing", "deriving", "investigating", "looking up, search, inquiry" (e.g., looking up a table, database, or other data structures), or "ascertaining" is deemed as "determining". Further, the "determining" may include a case in which "receiving" (e.g., receiving information), "transmitting" (e.g., transmitting information), "inputting", "outputting", or "accessing" (e.g., accessing data in a memory) is deemed as "determining". Further, the "determining" may include a case in which "resolving", "selecting", "choosing", "establishing", "comparing", or the like is deemed as "determining". In other words, the "determining" may include a case in which a certain action or operation is deemed as "determining". Further, "decision" may be read as "assuming", "expecting", or "considering", etc.

The term "connected" or "coupled" or any variation thereof means any direct or indirect connection or connection between two or more elements and may include the presence of one or more intermediate elements between the two elements "connected" or "coupled" with each other. The coupling or connection between the elements may be physical, logical, or a combination thereof. For example, "connection" may be read as "access". As used in the present disclosure, the two elements may be thought of as being "connected" or "coupled" to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description "based on" used in the present specification does not mean "based on only" unless otherwise specifically noted. In other words, the phrase "base on" means both "based on only" and "based on at least".

Any reference to an element using terms such as "first" or "second" as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

"Means" included in the configuration of each of the above apparatuses may be replaced by "parts," "circuits," "devices," etc.

In the case where the terms "include", "including" and variations thereof are used in the present disclosure, these terms are intended to be comprehensive in the same way as the term "comprising". Further, the term "or" used in the present specification is not intended to be an "exclusive or".

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission and reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe. Further, a slot may be referred to as a unit time. The unit time may vary for each cell depending on the numerology.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in a RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a UE, one or more BWPs may be configured in one carrier.

At least one of the configured BWPs may be activated, and the UE may assume that the UE will not transmit and receive signals/channels outside the activated BWP. It should be noted that the terms "cell" and "carrier" in this disclosure may be replaced by "BWP."

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in a RB, the number of symbols in a TTI, the symbol length, the cyclic prefix (CP) length, and the like, may be changed in various ways.

In the present disclosure, where an article is added by translation, for example "a", "an", and "the", the disclosure may include that the noun following these articles is plural.

In this disclosure, the term "A and B are different" may mean "A and B are different from each other." It should be noted that the term "A and B are different" may mean "A and B are different from C." Terms such as "separated" or "combined" may be interpreted in the same way as the above-described "different".

An aspect/embodiment described in the present specification may be used independently, may be used in combination, or may be used by switching according to operations. Further, notification (transmission/reporting) of predetermined information (e.g., notification (transmission/reporting) of "X") is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station

110 Transmission unit

120 Reception unit

130 Configuration unit

140 Control unit

20 Terminal

210 Transmission unit

220 Reception unit

230 Configuration unit

240 Control unit

1001 Processor

1002 Storage device

1003 Auxiliary storage device

1004 Communication device

1005 Input device

1006 Output device

1. A terminal that uses a second subcarrier spacing greater than a first subcarrier spacing, comprising:
a transmitter configured to transmit predetermined terminal capability information relating to PDCCH (Physical Downlink Control Channel) monitoring;
a controller configured to perform the PDCCH monitoring with a number of PDCCH candidates equal to a maximum number of PDCCH candidates in the first subcarrier spacing; and
a receiver configured to receive downlink control information transmitted on the monitored PDCCH.

2. The terminal as claimed in claim 1,
wherein the predetermined terminal capability information comprises a number of slots constituting a slot group in which the PDCCH monitoring is performed, and a number of pieces of the downlink control information that is monitorable in the slot group,
wherein the number of slots constituting the slot group takes different values for respective ones of a plurality of the second subcarrier spacings, and
wherein a length of the slot group is equal to a one-slot length in the first subcarrier spacing.

3. The terminal as claimed in claim 1, wherein a number of pieces of the downlink control information is defined respectively for time division duplex and frequency division duplex, and the downlink control information is information for scheduling unicast downlink or uplink.

4. A communication method executed by a terminal that uses a second subcarrier spacing greater than a first subcarrier spacing, the method comprising:
transmitting predetermined terminal capability information relating to PDCCH (Physical Downlink Control Channel) monitoring;
performing the PDCCH monitoring with a number of PDCCH candidates equal to a maximum number of PDCCH candidates in the first subcarrier spacing; and
receiving downlink control information transmitted on the monitored PDCCH.

5. A base station that uses a second subcarrier spacing greater than a first subcarrier spacing, comprising:
a receiver configured to receive, from a terminal, predetermined terminal capability information relating to PDCCH (Physical Downlink Control Channel) monitoring;
a controller configured to assume that the terminal performs the PDCCH monitoring with a number of PDCCH candidates equal to a maximum number of PDCCH candidates in the first subcarrier spacing; and
a transmitter configured to transmit, to the terminal, downlink control information on the monitored PDCCH.

6. A communication system including a terminal and a base station that use a second subcarrier spacing greater than a first subcarrier spacing,
wherein the terminal comprises:
a transmitter configured to transmit, to the base station, predetermined terminal capability information relating to PDCCH (Physical Downlink Control Channel) monitoring;
a controller configured to perform the PDCCH monitoring with a number of PDCCH candidates equal to a maximum number of PDCCH candidates in the first subcarrier spacing; and
a receiver configured to receive, from the base station, downlink control information transmitted on the monitored PDCCH; and
wherein the base station comprises:
a receiver configured to receive the predetermined terminal capability information from the terminal;
a controller configured to assume that the terminal performs the PDCCH monitoring with a number of PDCCH candidates equal to a maximum number of PDCCH candidates in the first subcarrier spacing; and
a transmitter configured to transmit the downlink control information to the terminal.
